(19) United States
(12) Patent Application Publication
(10) Pub. No.: US 2003/0126996 A1
(43) Pub. Date: Jul. 10, 2003

(54) Cookware with undulating cooking surface

(76) Inventor: Stanley K. Cheng, Kowloon (HK)

Correspondence Address: WOOD, HERRON & EVANS, LLP, 2700 CAREW TOWER, 441 VINE STREET, CINCINNATI, OH, 45202, US

(21) Appl. No.: 10/043,814

(22) Filed: Jan. 10, 2002

(51) Int. Cl. A47J 37/12

(52) U.S. Cl. 99/422; 99/403

(57) ABSTRACT

An article of cookware has a base with an upper cooking surface (8) on which food to be cooked is placed, which surface is provided with a regular pattern of concentric corrugations (10) in the form of ridges (12) and grooves (14) therebetween wherein the ridge (12) to ridge (12) spacing is in the range of 2.3 mm to 2.8 mm and the vertical distance of ridge (12) top to groove (14) bottom is in the range 0.05 mm to 1.5 mm.

### BACKGROUND OF THE INVENTION

The present invention relates to an article of cookware having a non-stick cooking surface and which is shaped with a pattern of corrugations or undulations.

It is well-known to provide articles of cookware such as frying pans, saucepans and the like with a non-planar cooking surface. For example, articles such as cast iron griddles or grill pans have traditionally been provided with ribbed or uneven surfaces to maintain the food spaced from the main body of the griddle or pan to allow a grilling-type of cooking effect.

Since people first started using cookware articles a major concern has been to prevent the food being cooked from adhering to the cookware. One of the most important developments in this respect was the development of non-stick coatings, and in particular silicone based coatings which are now near ubiquitous, such as those based on polytetrafluoroethylene (PTFE). As well as providing a surface to which food does not readily adhere during cooking, such coated surfaces are very easy to clean.

More recently, articles of cookware have been provided which have both non-planar cooking surfaces and non-stick coatings.

For example, the applicants have previously manufactured cookware articles where the cooking surface is provided with a series of closely spaced corrugations having a nonstick coating applied thereto, as disclosed in their U.S. Pat. No. 4,768,427. The corrugations comprise sharp peaks and valleys therebetween at a pitch spacing of about 1-2 mm, and depth of a similar magnitude. These have the effect that the contact between the food and the cooking surface is greatly reduced, for example to only about 15% of the overall surface area, reducing the tendency of the food to stick to the cooking surface. Moreover, continued use of the cookware results in wear at the peaks for example through the action of cooking implements and cleaning implements, but the major part of the surface which lies beneath the peaks remains unworn. The efficacy of such products is reflected in the significant commercial success which they have enjoyed.

Although highly successful, such products do require proper use, care and regular cleaning. If not properly cleaned food has a tendency to build up in the grooves of the cookware surface. Recently, with the advent of cookware made of hard-anodised aluminium which has a gray, very non-reflective porous surface giving an appearance somewhat akin to a traditional cast iron pan there has been a particular tendency for consumers to misuse such products by cleaning them in a manner similar to seasoning a cast iron pan, that is without water and detergent and simply wiping with a dry or oiled cloth or paper towel, which leads to eventual adherence of food in the grooves which eventually becomes burnt and difficult to remove.

The present invention is directed to providing a cooking surface which enjoys the benefits provided by the non-planar coated cooking surface and yet which is easier to clean and less susceptible to misuse.

### SUMMARY OF THE INVENTION

The pitch spacing of corrugations as disclosed in applicant's U.S. Pat. No. 4,768,427 was carefully selected to provide an appropriate degree of contact of food with the shaped cooking surface. The applicant has found that, surprisingly, excellent results are obtained if the spacing is increased to a value of about 2.5 mm, which corresponds to a pitch (number per inch) of about 10, and the profile of the ridges and valleys carefully selected.

According to the present invention there is provided an article of cookware having a base with an upper cooking surface on which food to be cooked is placed, which surface is provided with a pattern of concentric corrugations in the form of ridges and grooves therebetween wherein the ridge to ridge spacing is in the range 2.3 mm to 2.8 mm with the vertical distance from ridge top to groove bottom in the range 0.05 to 0.15 mm.

Most preferably, the ridge to ridge spacing is about 2.5 mm and the vertical distance of ridge top to groove bottom is about 0.1 mm. This shallow groove arrangement is a major departure from the structure of applicant's prior cookware.

The applicant has thus identified a combination of spacing and depth of corrugations which is highly effective. It is found that if the pitch of corrugations is increased much beyond the 10 pitch arrangement the food has a greatly increased tendency to adhere within the troughs. If the spacing is decreased the amount of cookware surface contacting the food and more particularly cooking utensils such as spatulas and the like, and cleaning utensils is too great such that the coating becomes worn with use.

Preferably, the pitch of valleys or grooves is also the same, at a spacing of about 2.5 mm, whereby there is a regular pattern of ridges and grooves, and with the pattern having a shallow smoothly curved profile free of sharp edges.

The selection of the small vertical distance of ridge top to groove bottom, and the smoothly curved profile shape is particularly important. If increased substantially food becomes more readily trapped with misuse and improper cleaning, whilst if reduced substantially, too great an amount of cooking surface contacts the food and contacts cooking and cleaning utensils and becomes liable to wear.

### BRIEF DESCRIPTION OF THE DRAWINGS

An embodiment of the invention is now described, by way of example only, with reference to the following drawings in which:

FIG. 1 shows a frying pan in accordance with an embodiment of the invention; and

FIG. 2 is an enlarged view of the cooking surface profile in a radial direction.

### DETAILED DESCRIPTION OF THE PREFERRED EMBODIMENT

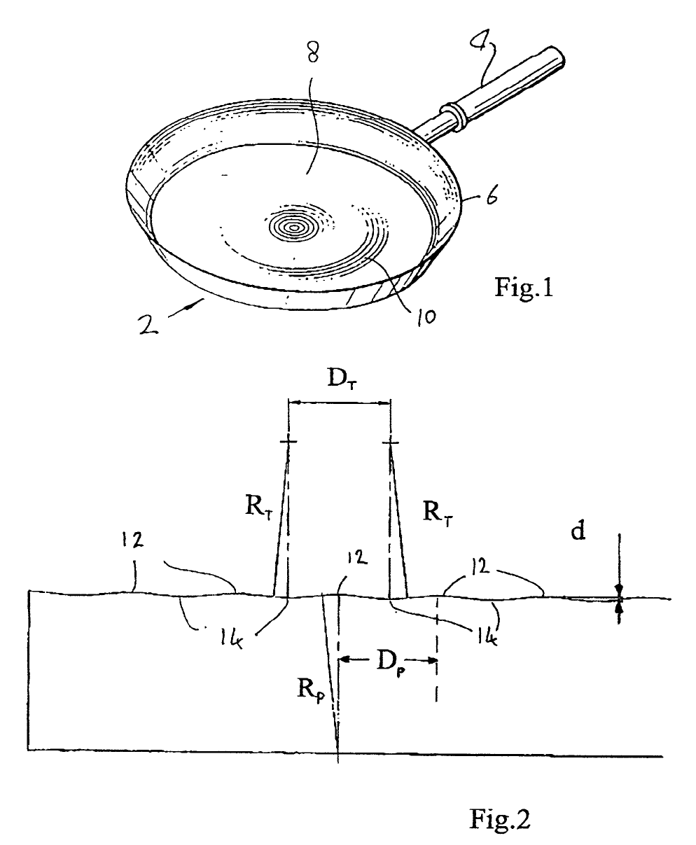

Turning to the Figures, FIG. 1 shows an article of cookware in this case a frying pan 2 but which may equally be a saucepan, milk pan, stock pot, casserole, baking pan or tray, grill pan or any other cookware article having a cooking surface. The frying pan 2 has a handle 4 and a main body 6 having an upper food-receiving cooking surface 8 having a non-sticking coating applied thereto.

The cooking surface 8 is provided at least over a major part thereof with a pattern of concentric spaced corrugations or undulations 10 in the form of ridges and groves of which only a few are illustrated in FIG. 1. Although a circular pattern is shown, other regular patterns can be utilised provided they are free of sharp corners or discontinuities at which food or oil would be liable to collect.

As can be seen more clearly in FIG. 2 which shows a radial section with the corrugations expanded laterally on a scale of about 1 to 10, these comprise a series of adjacent ridges and grooves shown in profile as peaks 12 and shallow troughs 14 therebetween. More particularly, the peaks 12 are spaced a distance Dp apart where Dp is about 2.5 mm, the troughs similarly spaced a distance Dp of 2.5 mm apart. Thus, the pitch of peaks is about 10-pitch (is 10 peaks to the inch). The vertical peak to trough distance d is about 0.1 mm. The profile of the corrugations between peaks and troughs is of shallow smoothly curved shape free of sharp edges or discontinuities of shape with both peaks and troughs having radii of curvature Rₚ and R_{T} of about 4 mm more particularly 4.06 mm.

Although a small departure from the 10 pitch arrangement is tolerated it is found that if the pitch of corrugations 10 is increased beyond about 11 pitch (about 2.3 mm) the food has a greatly increased tendency to adhere within the troughs. If the spacing is decreased from this to less than 9 pitch (about 2.8 mm) the amount of cookware surface contacting the food and more particularly cooking utensils and cleaning utensils is too great such that the coating becomes significantly worn with use. The selection of the depth of the troughs or the peak to trough vertical distanced is also very important as if this is increased substantially from the value of 0.1 mm much beyond 0.15 mm food more readily becomes trapped with misuse, whilst it is decreased to less than about 0.05 mm the cookware surface is not adequately protected by the peaks. Moreover, the smoothly undulating profile free of sharp edges is also important.

The pattern of corrugations 10 is preferably stamped into the pan body rather than being machined, as machining removes an amount of the base thickness. It is generally desired to maintain maximum thickness of the base for maintaining the good thermal properties of the base. Machining is also troublesome to perform as it produces a length of sharp scrap metal which must be disposed of. The non-stick coating is applied on top of the stamped pattern of corrugations, which is preferably a PTFE coating of a type employing a ceramic filler, such as the “Multiple reinforced technology” coatings of Dupont exhibiting superior durability as compared to traditional PTFE coatings. It is also found that the smoothly undulating profile of ridges and grooves is advantageous for the application of such ceramic filler-containing coatings. Prior shapes of ridges and grooves with sharp edges experience re-alignment of the fillers at the sharp edges of the peaks creating adhesion problems and reduced durability, as compared to the smooth shape of the present corrugations.

The pan 2 may be formed of or have a base formed of a variety of materials as is conventional such as stainless steel or aluminum. In the case of aluminum, hard-anodised aluminum is greatly preferred, as unanodised aluminum is relatively soft such that the pattern of corrugations as described above is then more susceptible to wear. In the case of stainless steel, before applying the non-stick coating the steel surface is arc-sprayed with small droplets of steel which bond to the surface creating a surface roughness to which the first coat of the non-stick coating, which is usually a mechanical bonding primer, can better adhere.

1. An article of cookware having a base with an upper cooking surface on which food to be cooked is placed, which surface is provided with a regular pattern of concentric corrugations in the form of ridges and grooves therebetween wherein the ridge to ridge spacing is in the range of 2.3 mm to 2.8 mm and the vertical distance of ridge top to groove bottom is in the range 0.05 mm to 1.5 mm.

2. An article of cookware according to claim 1 wherein the ridge to ridge spacing is about 2.5 mm.

3. An article of cookware according to claim 1 wherein the vertical distance of ridge top to groove bottom is about 0.1 mm.

4. An article of cookware according to claim 1 wherein the groove to groove spacing is about 2.5 mm.

5. An article of cookware according to claim 1 wherein the ridges and grooves have a shallow, curved profile free of sharp edges.

6. An article of cookware according to claim 3 wherein the curved profiles of the ridges and grooves have radii of curvature of about 4 mm.

7. An article of cookware according to claim 1 wherein the corrugations are formed in the base by stamping.

8. An article of cookware as defined in claim 1 wherein at least the base is formed of hard-anodized aluminum.

9. An article of cookware as defined in claim 1 wherein at least the base is formed of stainless steel having an upper cooking surface to which is arc sprayed a surface layer of stainless steel onto which the non-stick coating is applied.

10. An article of cookware having an upper cooking surface coated with a non-stick coating and formed with a smooth profile where the pitch of the ridges is about 10 per inch and the depth of the valleys from the ridge tops is about 0.1 mm.
